(19) United States
(12) Patent Application Publication
(10) Pub. No.: US 2016/0248660 A1
(43) Pub. Date: Aug. 25, 2016

(54) METHOD AND DEVICE FOR FORWARDING INFORMATION

(71) Applicant: Yulong Computer Telecommunication Scientific (Shenzhen) Co., Ltd., Shenzhen (CN)

(72) Inventor: Changzhan Zhou, Shenzhen (CN)

(21) Appl. No.: 15/140,700

(22) Filed: Apr. 28, 2016

Related U.S. Application Data
(63) Continuation-in-part of application No. PCT/CN2013/086165, filed on Oct. 29, 2013.

(51) Int. Cl. H04L 12/751; H04L 12/715

(52) U.S. Cl. CPC H04L 45/02; H04L 45/46

(57) ABSTRACT

Disclosed in the present disclosure are a method and device for forwarding information, which relate to the technical field of telecommunications and solve the problems that the information that a certain user has released can be propagated within a relatively small range and more operation cost can be consumed during the propagation. Specifically, the method of the present disclosure can comprise a network server receiving the information of the friendship circle released by a first user; determining whether a second user in the friendship circle of the first user has opened his or her own friendship circle permission to the first user; if yes, sending the information of the friendship circle released by the first user to a third user in the friendship circle of the second user, wherein the third user is not a user who belongs to the friendship circle of the first user.

### CROSS-REFERENCE TO RELATED APPLICATIONS

This application is a continuation-in-part of international patent application no. PCT/CN2013/086165, by YULONG COMPUTER TELECOMMUNICATION SCIENTIFIC (SHENZHEN) CO., LTD., filed on Oct. 29, 2013, and entitled METHOD AND DEVICE FOR FORWARDING INFORMATION, the disclosure of which is herein incorporated by reference in its entirety.

### TECHNICAL FIELD

The present disclosure relates to the technical field of telecommunication, and particularly to a method and device for forwarding information.

### BACKGROUND

At present, when propagating information through a Social Networking Services (SNS) application or platform, an Identity (ID) will be needed for everyone in the first place. People can register a user and then build their own social circle or friendship circle based on the registered user (for example, add as friend, follow, and etc.), wherein at least one friend will be included in the social circle.

User A can release information in his or her social circle, and friends (such as Friend B) in the social circle of User A will see the information; Friend B can forward the information if he or she is interested in it so that friends (such as Friend C) in the social circle of User B will see the information.

During the process of forwarding information, the propagation range of the released information depends solely on the size of the social circle of the user (that is to say, depends on the number of friends in the social circle), and even after forwarding, the range is still very limited. Moreover, the possibility of a secondary transmission (that is, the process of forwarding information by friends in the social circle) is very small because of the limited receiver of the first transmission (that is, the process of releasing information by a user), besides, operation cost will be consumed during the secondary transmission, for example, Friend B has to “Forward” or “Share.”

### SUMMARY

The present disclosure aims to provide a method and device for forwarding information, which can expand the range of information propagation without increasing the operation cost.

According to one aspect of the disclosure, it is provided a method for forwarding information, comprising receiving, by a network server, information of a friendship circle released by a first user, determining whether a second user in the friendship circle of the first user has permitted the first user to access a friendship circle of the second user, and based on a determination that the second user in the friendship circle of the first user has permitted the first user to access the friendship circle of the second user, sending the information of the friendship circle released by the first user to a third user in the friendship circle of the second user, wherein the third user is not a user belonging to the friendship circle of the first user.

According to another aspect of the disclosure, it is provided a device for forwarding information, comprising a receiving unit, configured to receive information of a friendship circle released by a first user, a determining unit, configured to determine whether a second user in the friendship circle of the first user has permitted the first user to access a friendship circle of the second user, and a sending unit, configured to, based on a determination that the second user in the friendship circle of the first user has permitted the first user to access the friendship circle of the second user, send the information of the friendship circle released by the first user to a third user in the friendship circle of the second user, wherein the third user is not a user belonging to the friendship circle of the first user.

According to another aspect of the disclosure, it is provided an apparatus, comprising a memory configured to store computer-readable program instructions and a processor. The processor is configured to execute the computer-readable program instructions to receive information of a friendship circle released by a first user, determine whether a second user in the friendship circle of the first user has permitted the first user to access a friendship circle of the second user, and based on a determination that the second user in the friendship circle of the first user has permitted the first user to access the friendship circle of the second user, sending the information of the friendship circle released by the first user to a third user in the friendship circle of the second user, wherein the third user is not a user belonging to the friendship circle of the first user.

According to another aspect of the disclosure, it is provided a computer-readable storage medium configured to store computer-readable program instructions, wherein the computer-readable program instructions are executed at an apparatus to receive information of a friendship circle released by a first user, determine whether a second user in the friendship circle of the first user has permitted the first user to access a friendship circle of the second user, and based on a determination that the second user in the friendship circle of the first user has permitted the first user to access the friendship circle of the second user, sending the information of the friendship circle released by the first user to a third user in the friendship circle of the second user, wherein the third user is not a user belonging to the friendship circle of the first user.

By means of the method and device according to the implementations of the disclosure, the network server can receive the information of the friendship circle released by the first user, and determine whether the second user in the friendship circle of the first user has opened his or her own friendship circle permission to the first user, and if yes, send the information of the friendship circle released by the first user to the third user in the friendship circle of the second user, wherein the third user is not a user who belongs to the friendship circle of the first user. In this way, even if the second user does not forward the information released by the first user, the network server can send the information to the friendship circle opened by the second user, that is to say, the information released by the first user will be received by users in the friendship circle opened by the second user, and the range of information propagation is expanded without increasing the operation cost.

### BRIEF DESCRIPTION OF THE DRAWINGS

The technical solution of the present disclosure or the related art will be more clearly understood from the following detailed description taken in conjunction with the accompanying drawings; it will be apparent to one of ordinary skill in the art that the accompanying drawings described below are merely implementations of the disclosure and other drawings can be obtained out of them, in which:

FIG. 1 is a flowchart illustrating a method for forwarding information according to an implementation of the disclosure;

FIG. 2 is a flowchart illustrating another method for forwarding information according to an implementation of the disclosure;

FIG. 3 is a flowchart illustrating a method for opening the friendship circle permission to the first user by the second user according to an implementation of the disclosure;

FIG. 4 is a flowchart illustrating another method for opening the friendship circle permission to the first user by the second user according to an implementation of the disclosure;

FIG. 5a is a structural schematic diagram illustrating the propagation range of the information released by User A in the related art;

FIG. 5b is a structural schematic diagram illustrating the propagation range of the information released by User A in the method of FIG. 3;

FIG. 6 is a structural schematic diagram illustrating a device for forwarding information according to an implementation of the disclosure;

FIG. 7 is a structural schematic diagram illustrating another device for forwarding information according to an implementation of the disclosure; and

FIG. 8 is a block diagram illustrating the apparatus of the implementation of the disclosure.

### DETAILED DESCRIPTION

The foregoing descriptions are merely preferred embodiments or implementations rather than limitations of the present disclosure. Various modifications and alterations can be made to the present disclosure for those skilled in the art. Any modification, equivalent substitution, improvement or the like made within the spirit and principle of the present disclosure shall fall into the protection scope of the present disclosure.

In the related art, as mentioned above, the propagation range of the released information depends solely on the size of the social circle of the user (that is to say, depends on the number of friends in the social circle), and even after forwarding, the range is still very limited. Moreover, the possibility of a secondary transmission (that is, the process of forwarding information by friends in the social circle) is very small because of the limited receiver of the first transmission (that is, the process of releasing information by a user), besides, operation cost will be consumed during the secondary transmission, for example, Friend B has to “Forward” or “Share.”

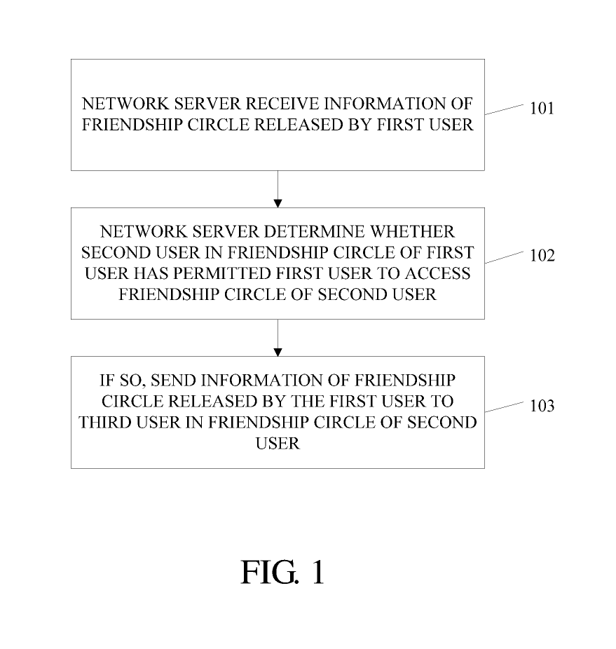

In order to solve the problems described above, one implementation of the disclosure provides a method for forwarding information. As shown in FIG. 1, the method comprises:

At step 101, a network server receives information of a friendship circle released by a first user. A friendship circle can include, for example, data or information about a circle or group of friends associated with a user.

When propagating information through the Social Networking Services (SNS) application or platform, people can register an account and release, forward, or browse information under the registered account, or people can build their own friendship circle in which at least two users are included. After being released or forwarded by a user in the friendship circle, the information can be received by all users in the friendship circle of the said user.

At step 102, the network server determines whether a second user in the friendship circle of the first user has opened his or her own friendship circle permission to the first user.

At step 103, if yes, the network server sending the information of the friendship circle released by the first user to a third user in the friendship circle of the second user, wherein the third user is not a user who belongs to the friendship circle of the first user.

It should be noted that, in the present disclosure, based on the scope of the friendship circle permission of the second user opened to the first user, the third user can be one or more users in the friendship circle of the second user.

In this implementation, if the friendship circle permission of the second user has been opened to the first user, then after receiving the information of the friendship circle released by the first user, the network server can search for the second user and the third user in the friendship circle opened to the first user by the second user, and then send the above information to the third user. In this way, after being released or forwarded by the first user, the information will be received by all the third users in the friendship circle opened by the second user.

By adopting the above scheme, after being released by the first user, the information of the friendship circle will be sent by the network server to the third user in the friendship circle opened to the first user by the second user, and there is no need for the second user to perform operations such as forward, that is, users in the friendship circle opened by the second user can receive the information of the friendship circle released by the first user, thereby expanding the range of information propagation without increasing the operation cost.

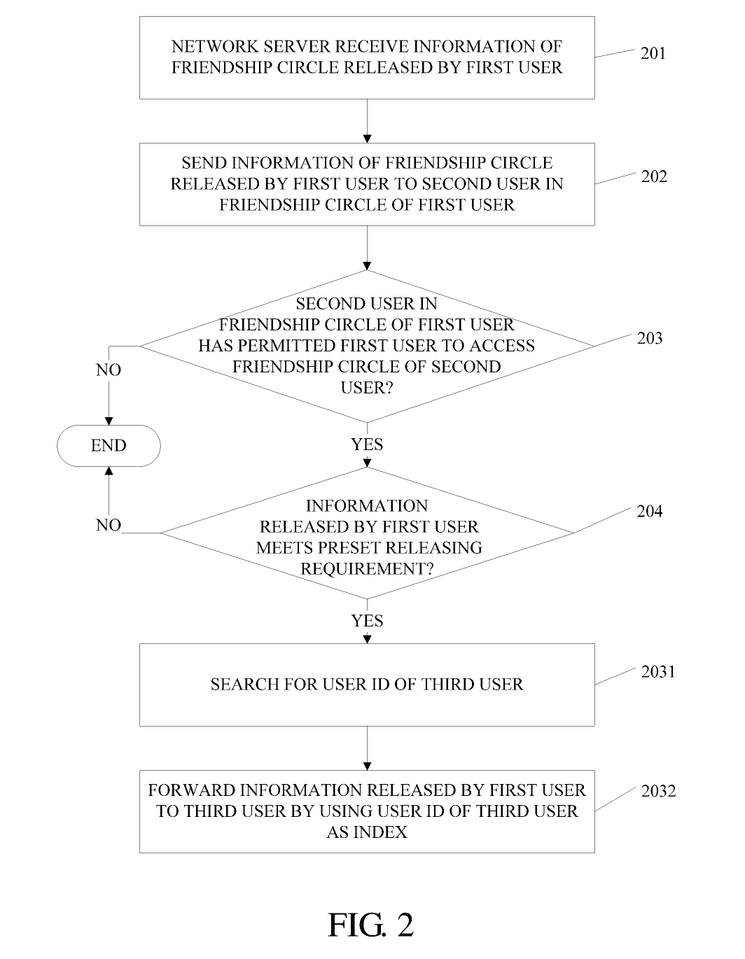

FIG. 2 illustrates another method for forwarding information according to an implementation of the disclosure, which is a further expansion and optimization of the method as shown in FIG. 1 and comprises:

At step 201, a network server receives information of a friendship circle released by a first user.

At step 202, the above information is sent to a second user in the friendship circle of the first user.

In this implementation, the second user can be any one or more users in the friendship circle of the first user.

As a realization, the corresponding relationship between the first user and the second user can be stored in the network server, after receiving the information of the friendship circle of the first user, the network server will search the friendship circle of the first user, that is, search for the second user corresponding to the first user, and then send the information of the friendship circle released by the first user to all users (include the second user) in the friendship circle of the first user.

It should be emphasized that the information released by the first user includes but is not limited to the information created by the first user; it can also be the information forwarded by the first user.

At step 203, it is determined whether a second user in the friendship circle of the first user has opened his or her own friendship circle permission to the first user; if yes, proceeds to step 204, otherwise, the process ends.

In this implementation, in order to expand the range of information propagation, the second user can open his or her own friendship circle to the first user, that is, open the permission of the third user to the first user; thus, after being released by the first user, the information will be received by not only the users (include the second user) in the friendship circle of the first user, but also the third user in the friendship circle opened by the second user. In other words, the information released by the first user will be propagated in the friendship circle of the first user as well as the friendship circle of the second user. Compared with the situation where the permission of the third user is not opened, the propagation range of the information released by the first user is expanded.

In order to facilitate the subsequent operations, first of all, the network server should determine whether the second user has opened his or her own friendship circle permission to the first user.

As a realization of this implementation, if the second user has opened his or her own friendship circle permission to the first user, the corresponding relationship between the first user and the third user will be stored in the network server. Thus, the network server can determine whether a third user corresponding to the first user has been stored; if yes, the second user has opened his or her own friendship circle permission to the first user, otherwise, the second user has not opened his or her own friendship circle permission to the first user.

The following is a description of the method of opening the friendship circle permission of the second user to the first user, wherein this step can be performed before or after step 201.

Specifically, the method of opening the friendship circle permission of the second user to the first user comprises: the second user opening his or her own friendship circle permission to the first user in a passive way; or, the second user opening his or her own friendship circle permission to the first user on his or her own initiative.

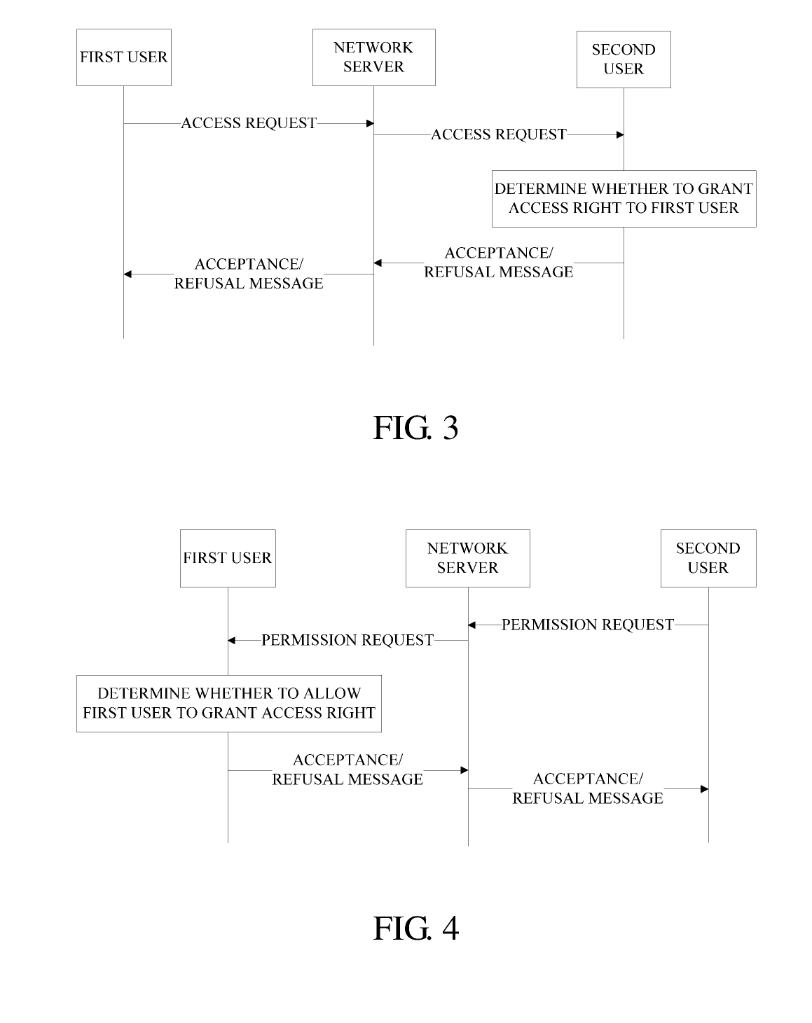

As illustrated in FIG.3, the step in which the second user opens his or her own friendship circle permission to the first user in a passive way can include but is not limited to:

A friendship circle permission opening request, namely an “access request,” is received by the network server from the first user, wherein the access request is used to instruct the second user to open all or part of the designated friends in the friendship circle thereof as the third user to the first user to access. The network server forwards the access request to the second user, and determines whether the access request is accepted; if yes, the network server records the first user and the third user in association with each other, and optionally, sends an acceptance message to the first user; otherwise, the network server sends a refusal message to the first user.

The step in which the first user and the third user are recorded in association with each other includes but is not limited to: the corresponding relationship of the first user and the third user is recorded in association with each other, as a result, if the network server wants to forward the information of the friendship circle released by the first user to the second user, it will need to acquire the third user corresponding to the first user and forward the information released by the first user to the third user.

As illustrated in FIG. 4, the step in which the second user opens his or her own friendship circle permission to the first user on his or her own initiative can include but is not limited to:

A friendship circle permission opening request, namely a “permission request,” is received by the network server from the second user, the permission request is used to request to open all or part of the designated friends in the friendship circle of the second user as the third user to the first user to access. The network server forwards the permission request to the first user, and determines whether the permission request is accepted; if yes, the network server records the first user and the third user in association with each other, and optionally, sends an acceptance message to the second user; otherwise, the network server sends a refusal message to the second user.

As a realization of this implementation, the second user can determine whether to open the permission of the third user to the first user based on the gender, preference, age, and other factors of the first user.

For example, if the first user prefers photography and often releases or forwards information about it, the second user can choose friends who prefer photography from his or her own friendship circle as the third user. As a further example, the first user can be provided with basic information (such as high school, college school, etc.), and the second user can choose friends who have the same or some of the same basic information with the first user from his or her own friendship circle as the third user.

In the implementations of the disclosure, there is no restriction on the friendship circle and it can be set according to actual needs, for example, it can be the friendship circle of an address book or social apps, or, it can be one-way followed friends or two-way followed friends in a social network.

Moreover, the second user can have discretion in determining whether to open the friendship circle to the first user.

For example, the second user can determine whether to open the friendship circle permission to the first user based on his or her reputation (this is an example and the present disclosure is not limited thereto). Specifically, refuse to open the friendship circle permission if the first user has bad reputation or poor evaluation, and optionally, a refusal message can be sent to the first user.

In order to avoid spam being sent to the third user, the second user can set the type of the information that is not allowed to be sent to the third user and so on, and transmit the setting to the network server, such that after receiving an information releasing request from the first user, the network server can determine whether to forward the information released by the first user to the third user according to the setting.

For example, if the third user prefers photography, the setting can be that, only photography related information can be sent to the third user.

In the implementations of the disclosure, there is no restriction on the method of setting the type of the information that is not allowed to be sent to the third user, and it can be set according to actual needs, no further description is provided for the sake of clarity.

At step 204, it is determined whether the information released by the first user meets a preset releasing requirement; if yes, proceeds to step 2031, otherwise, the process ends.

As a realization of this implementation, the preset releasing requirement can includes but is not limited to: the number of times of forwarding, charging, the number of times of collection, and the type of the information released by the first user, and so on.

For example, if the preset releasing requirement is that the number of times of forwarding of the information should be greater than 50, then after receiving the information releasing request from the first user, the network server will determine whether the number of times of forwarding of the information released by the first user is greater than 50, and if yes, the requirement is met. As a further example, if the preset releasing requirement is that the fee charged for acquiring information should be less than 3 dollar, then after receiving the information releasing request from the first user, the network server will determine whether the fee charged for acquiring the information released by the first user is less than 3 dollar, and if yes, the requirement is met.

In the implementations of the disclosure, there is no restriction on the method of determining whether the information released by the first user meets the preset releasing requirement, and it can be set according to actual needs, no further description is provided for the sake of clarity.

The step 203 described above can also be achieved through the following way, comprises:

At step 2031, searching for the user ID (user identifier) of the third user.

As a realization of this implementation, if the second user decides to open the friendship circle permission to the first user, the network server can record the first user and the third user in association with each other, for example, the corresponding relationship between the first user and the third user can be stored in a forwarding relationship table. Thus, after receiving the information releasing request from the first user and forwarding the information released by the first user to the second user, the network server can search the forwarding relationship table for the user ID of the third user corresponding to the first user.

In the implementations of the disclosure, as to the method of searching for the user ID of the third user as well as the storage location of the user ID, there is no restriction, and it can be set according to actual needs, no further description is provided for the sake of clarity.

At step 2032, forwarding the information released by the first user to the third user by using the user ID of the third user as an index.

The user ID of the first user (for example, the name, the web link corresponding to the first user) can be included in the information released by the first user, thus, after receiving the information, the third user can establish connection with the first user, thereby expanding the friendship circle thereof.

By means of the scheme described above, the network server can receive the information of the friendship circle released by the first user, search for the second user and forward the information released by the first user thereto. Besides, the network server can determine whether the second user in the friendship circle of the first user has opened his or her friendship circle permission to the first user; if yes, the information released by the first user will be sent to the third user in the friendship circle of the second user, wherein the third user is not a user who belongs to the friendship circle of the first user. In this way, after being released by the first user, the information will be sent by the network server to, not only the second user (the step of sending the information released by the first user to the second user is not provided for the sake of clarity), but also the friendship circle opened by the second user, and there is no need for the second user to perform operations such as forward. That is to say, users in the friendship circle opened by the second user will receive the information released by the first user, and the range of information propagation is expanded without increasing the operation cost.

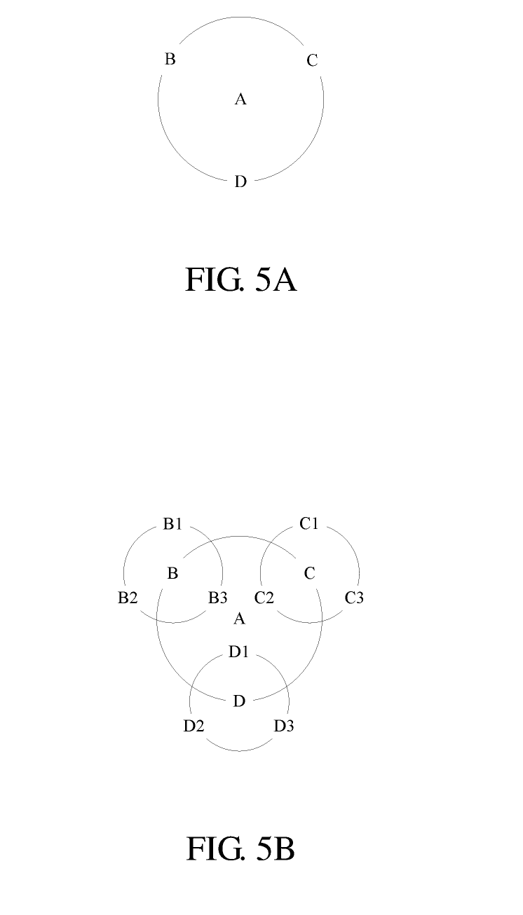

For example, as shown in FIG. 5a, users in the friendship circle of User A include but are not limited to: User B, User C, and User D. In the related art, after being released or forwarded by User A, the information can only be received by User B, User C, and User D. As shown in FIG. 5b, by means of the scheme of the implementations of the disclosure, after being released or forwarded by User A, the information will be received by not only User B, User C, and User D, but also users (for example, include but are limited to User D1, User D2, User D3, User C1, User C2, User C3, User B1, User B2, User B3, etc.) in the friendship circle of User B, User C, and User D.

Moreover, the second user can select the third user according to the first user and preset a releasing requirement, the information released by the first user will not be sent to the third user if it does not meets the preset releasing requirement, thus avoid spam being sent to the third user.

In the following, several examples are provided in order to facilitate the understanding of the above implementations, but the application of the implementations is not limited thereto.

### EXAMPLE 1

User A belongs to a photography circle SNS, after finding a photography platform which publishes good photography skills and works regularly, User A can open the permission of the photography circle SNS to the photography platform, then users in the photography circle SNS will receive the information released by the photography platform.

### EXAMPLE 2

Both User C and User D do business on a social shopping site, and the site is provided with a social shopping circle in which User C and User D are included, that is, User C and User D are friends in the social shopping circle. Rely on the personal reputation and product quality, User C and User D opened their respective friendship circle permission to each other; thus, the product information released by User C will be received by all users in the friendship circle of User D, and vice versa.

Provided in the following are several device implementations, which corresponding to the method implementations described above respectively.

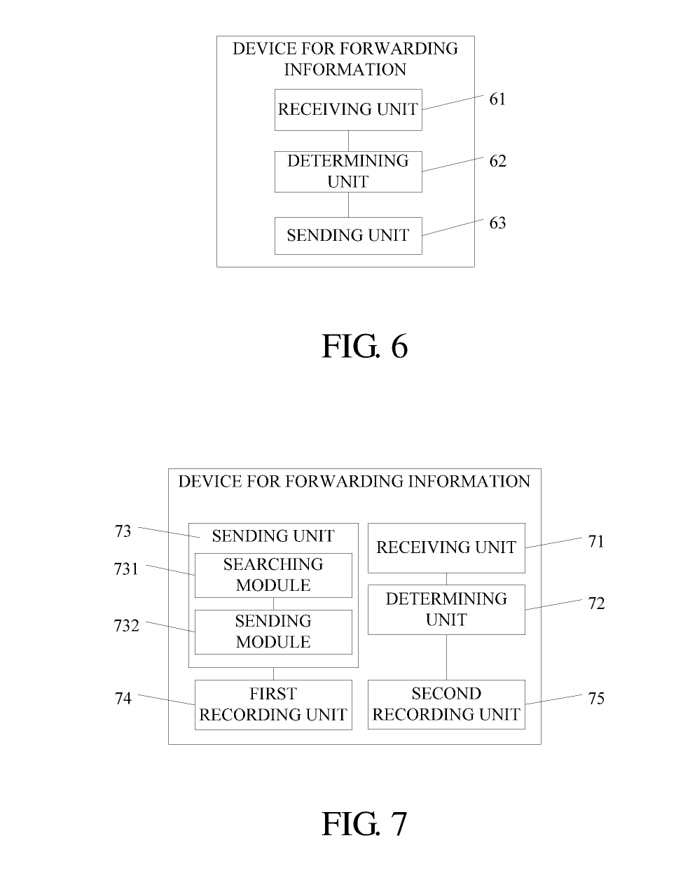

As shown in FIG. 6, the present implementation provides a device for forwarding information, which comprises:

a receiving unit 61, configured to receive information of a friendship circle released by a first user;

a determining unit 62, configured to determine whether a second user in the friendship circle of the first user has opened his or her own friendship circle permission to the first user; and

a sending unit 63, configured to send the information of the friendship circle released by the first user to a third user in the friendship circle of the second user if the determination result of the determining unit 62 is yes, wherein the third user is not a user who belongs to the friendship circle of the first user.

Thus, the following scheme is achieved, that is, the receiving unit, configured to receive the information of the friendship circle released by the first user; the determining unit, configured to determine whether the second user in the friendship circle of the first user has opened his or her own friendship circle permission to the first user; and the sending unit, configured to send the information of the friendship circle released by the first user to the third user in the friendship circle of the second user if the determination result of the determining unit is yes, wherein the third user is not a user who belongs to the friendship circle of the first user; wherein the sending unit is further configured to search for the second user and send the information released by the first user to the second user. By means of the scheme described above, after being released by the first user, the information can be sent to the friendship circle opened by the second user through the network server without performing operations (such as forward) by the second user, that is to say, users in the friendship circle opened by the second user can receive the information released by the first user, and the range of information propagation is expanded without increasing the operation cost.

As shown in FIG. 7, it is provided a device for forwarding information, which is a further expansion and optimization of the device of FIG.6 and can comprise:

a receiving unit 71, configured to receive the information released by a first user;

a determining unit 72, configured to determine whether a second user in the friendship circle of the first user has opened his or her own friendship circle permission to the first user; and

a sending unit 73, configured to send the information of the friendship circle released by the first user to a third user in the friendship circle of the second user if the determination result of the determining unit 72 is yes, wherein the third user is not a user who belongs to the friendship circle of the first user.

The receiving unit 71 is further configured to receive a friendship circle permission opening request from the first user before receiving the information of the friendship circle released by the first user, wherein the above request is used to instruct the second user to open all or part of the designated friends in the friendship circle thereof as the third user to the first user.

The sending unit 73 is further configured to forward the friendship circle permission opening request to the second user.

The determining unit 72 is further configured to determine whether the request is accepted by the second user.

The device for forwarding information can further comprises:

a first recording unit 74, configured to record the first user and the third user in association with each other if the determination result of the determining unit 72 is yes.

Alternatively, the receiving unit 71 is further configured to receive a friendship circle permission opening request from the second user before receiving the information of friendship circle released by the first user, the request is used to request to open all or part of the designated friends in the friendship circle of the second user as the third user to the first user.

The sending unit 73 is further configured to forward the friendship circle permission opening request to the first user.

The determining unit 72 is further configured to determine whether the request is accepted by the first user.

The device for forwarding information can further comprises:

a second recording unit 75, configured to record the first user and the third user in association with each other if the determination result of the determining unit 72 is yes.

The sending unit 73 further comprises:

a searching module 731, configured to search for the user ID of the third user; and

a sending module 732, configured to send the information released by the first user to the third user by using the user ID of the third user as an index.

The determining unit 72 is further configured to determine whether the information released by the first user meets a preset releasing requirement before forwarding the information to the third user in the friendship circle of the second user.

The sending unit 73 is further configured to forward the information released by the first user to the third user if the determination result of the determining unit 72 is yes.

Thus, the following scheme is achieved, that is, the receiving unit, configured to receive the information of the friendship circle released by the first user; the determining unit, configured to determine whether the second user in the friendship circle of the first user has opened his or her own friendship circle permission to the first user; and the sending unit, configured to send the information of the friendship circle released by the first user to the third user in the friendship circle of the second user if the determination result of the determining unit is yes, wherein the third user is not a user who belongs to the friendship circle of the first user; wherein the sending unit is further configured to search for the second user and send the information released by the first user to the second user. By means of the scheme described above, after being released by the first user, the information can be sent to the friendship circle opened by the second user through the network server without performing operations (such as forward) by the second user, that is to say, users in the friendship circle opened by the second user can receive the information released by the first user, and the range of information propagation is expanded without increasing the operation cost.

Moreover, the second user can select the third user according to the first user and preset a releasing requirement, the information released by the first user will not be sent to the third user if it does not meets the preset releasing requirement, thus avoid spam being sent to the third user.

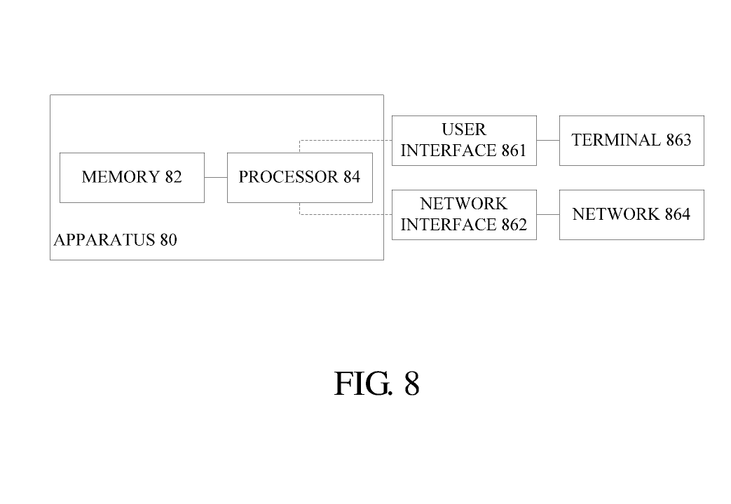

According to a further implementation of the disclosure, it is provided an apparatus; FIG. 8 is a block diagram illustrating the apparatus.

As shown in FIG. 8, the apparatus 80 comprises: a memory 82, configured to store computer-readable program code; and a processor 84, connected to the memory 82 via wired or wireless connections (such as via a bus which is not illustrated in the figure) and configured to invoke the computer-readable program code to execute predetermined process. In some implementations, memory 82 can be a random access memory device (RAM), a read-only memory device (ROM), an optical disc, a magnetic disc, or any other suitable type of storage device. In some implementations, memory 82 can be distributed across multiple machines or devices such as network-based memory or memory in multiple machines performing operations that can be described herein as being performed using a single computer or computing device for ease of explanation. In some implementations, processor 84 can include at least one processing unit such as a central processing unit (CPU) or any other type of device, or multiple devices, capable of manipulating or processing information now-existing or hereafter developed. Although the examples herein can be practiced with a single processor as shown, advantages in speed and efficiency can be achieved using more than one processor. For example, processor 84 can be distributed across multiple machines or devices (each machine or device having one or more of processors) that can be coupled directly or across a local area or other network. As shown in FIG. 8, the processor 84 can but not necessarily connect to a terminal 863 through a user interface 861 or to a network 864 through a network interface 862. Alternatively, the processor can also connect to the outside terminal or network in a wireless manner.

As a realization, the predetermined process includes but is not limited to: receiving information of a friendship circle released by a first user; determining whether a second user in the friendship circle of the first user has opened his or her own friendship circle permission to the first user; and if yes, sending the information of the friendship circle released by the first user to a third user in the friendship circle of the second user, wherein the third user is not a user who belongs to the friendship circle of the first user.

According to a further implementation of the disclosure, it is provided a computer-readable storage medium configured to store computer-readable program code.

The computer-readable storage medium can be referred to as a computer-readable non-transitory storage medium or tangible computer-readable medium. Examples of computer-readable storage medium include but are not limited to: magnetic hard disk drive, solid state hard disk, flash memory, USB thumb drive, RAM, ROM, magneto-optical disk, and the register file of the processor.

The term computer readable-storage medium also refers to various types of recording media capable of being accessed by the computer device via a network or communication link. For example, data can be retrieved over a modem, over the internet, or over a local area network. References to a computer-readable storage medium should be interpreted as possibly being multiple computer-readable storage mediums. For example, the computer-readable storage medium can be multiple computer-readable storage medium within the same computer system, or, can be computer readable storage medium distributed amongst multiple computer systems or computing devices.

In this implementation, the computer-readable program code running on an apparatus(such as the apparatus 80 as described above) to execute the following: receiving information of a friendship circle released by a first user; determining whether a second user in the friendship circle of the first user has opened his or her own friendship circle permission to the first user; and if yes, sending the information of the friendship circle released by the first user to a third user in the friendship circle of the second user, wherein the third user is not a user who belongs to the friendship circle of the first user.

As described above, a person skilled in the art should be noted that, all or a portion of aspects of the disclosure described herein can be implemented using a general purpose computer/processor with a computer program that, when executed, carries out any of the respective techniques, algorithms and/or instructions described herein. In addition, or alternatively, for example, a special purpose computer/processor can be utilized which can contain specialized hardware for carrying out any of the techniques, algorithms, or instructions described herein.

The implementations of computing devices as described herein (and the algorithms, methods, instructions, etc., stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination.

The aspects herein can be described in terms of functional block components and various processing operations. Such functional blocks can be realized by any number of hardware and/or software components that perform the specified functions. For example, the described aspects can employ various integrated circuit components, e.g., memory elements, processing elements, logic elements, look-up tables, and the like, which can carry out a variety of functions under the control of one or more microprocessors or other control devices. Similarly, where the elements of the described aspects are implemented using software programming or software elements the disclosure can be implemented with any programming or scripting language such as C, C++, Java, assembler, or the like, with the various algorithms being implemented with any combination of data structures, objects, processes, routines or other programming elements. Functional aspects can be implemented in algorithms that execute on one or more processors. Furthermore, the aspects of the disclosure could employ any number of conventional techniques for electronics configuration, signal processing and/or control, data processing and the like. The word “element” is used broadly and is not limited to mechanical or physical embodiments or aspects, but can include software routines in conjunction with processors, etc.

Implementations or portions of implementations of the above disclosure can take the form of a computer program product accessible from, for example, a computer-usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or a semiconductor device. Other suitable mediums are also available. Such computer-usable or computer-readable media can be referred to as non-transitory memory or media, and can include RAM or other volatile memory or storage devices that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

Any of the individual or combined functions described herein as being performed as examples of the disclosure can be implemented using machine readable instructions in the form of code for operation of any or any combination of the aforementioned computational hardware. Computational code can be implemented in the form of one or more modules by which individual or combined functions can be performed as a computational tool, the input and output data of each module being passed to/from one or more further module during operation of the methods and systems described herein.

Information, data, and signals can be represented using a variety of different technologies and techniques. For example, any data, instructions, commands, information, signals, bits, symbols, and chips referenced herein can be represented by voltages, currents, electromagnetic waves, magnetic fields or particles, optical fields or particles, other items, or a combination of the foregoing.

This specification has been set forth with various headings and subheadings. These are included to enhance readability and ease the process of finding and referencing material in the specification. These heading and subheadings are not intended, and should not be used, to affect the interpretation of the claims or limit claim scope in any way. The particular implementations shown and described herein are illustrative examples of the disclosure and are not intended to otherwise limit the scope of the disclosure in any way.

All references, including publications, patent applications, and patents, cited herein are hereby incorporated by reference to the same extent as if each reference were individually and specifically indicated as incorporated by reference and were set forth in its entirety herein.

The above-described aspects have been described in order to allow easy understanding of the present disclosure and do not limit the present disclosure. To the contrary, the disclosure is intended to cover various modifications and equivalent arrangements included within the scope of the appended claims, which scope is to be accorded the broadest interpretation so as to encompass all such modifications and equivalent structure as is permitted under the law.

What is claimed is:

1. A method for forwarding information, comprising:
receiving, by a network server, information of a friendship circle released by a first user;
determining whether a second user in the friendship circle of the first user has permitted the first user to access a friendship circle of the second user; and
based on a determination that the second user in the friendship circle of the first user has permitted the first user to access the friendship circle of the second user, sending the information of the friendship circle released by the first user to a third user in the friendship circle of the second user, wherein the third user is not a user belonging to the friendship circle of the first user.

2. The method of claim 1, prior to receiving, by the network server, the information of the friendship circle released by the first user, further comprising:
receiving, from the first user, an access request, wherein the access request is used to instruct the second user to designate all or part of friends in the friendship circle of the second user as the third user for the first user to access;
forwarding the access request to the second user and determining whether the access request is accepted by the second user; and
based on a determination that the access request is accepted by the second user, recording the first user and the third user as an association.

3. The method of claim 2, prior to sending the information of the friendship circle released by the first user to the third user in the friendship circle of the second user, further comprising:
determining whether the information released by the first user meets a preset releasing requirement; and
based on a determination that the information released by the first user meets the preset releasing requirement, sending the information of the friendship circle released by the first user to the third user.

4. The method of claim 1, prior to receiving, by the network server, the information of the friendship circle released by the first user, further comprising:
receiving, from the second user, a permission request, wherein the permission request is used to request to designate all or part of the friends in the friendship circle of the second user as the third user for the first user to access;
forwarding the permission request to the first user and determining whether the request is accepted by the first user; and
based on a determination that the permission request is accepted by the first user, recording the first user and the third user as an association.

5. The method of claim 4, prior to sending the information of the friendship circle released by the first user to the third user in the friendship circle of the second user, further comprising:
determining whether the information released by the first user meets a preset releasing requirement; and
based on a determination that the information released by the first user meets the preset releasing requirement, sending the information of the friendship circle released by the first user to the third user.

6. The method of claim 1, wherein sending the information of the friendship circle released by the first user to the third user in the friendship circle of the second user comprises:
searching for a user identifier of the third user; and
forwarding the information released by the first user to the third user by using the user identifier of the third user as an index.

7. The method of claim 6, prior to sending the information of the friendship circle released by the first user to the third user in the friendship circle of the second user, further comprising:
determining whether the information released by the first user meets a preset releasing requirement; and
based on a determination that the information released by the first user meets the preset releasing requirement, sending the information of the friendship circle released by the first user to the third user.

8. The method of claim 1, prior to sending the information of the friendship circle released by the first user to the third user in the friendship circle of the second user, further comprising:
determining whether the information released by the first user meets a preset releasing requirement; and
based on a determination that the information released by the first user meets the preset releasing requirement, sending the information of the friendship circle released by the first user to the third user.

9. A device for forwarding information, comprising:
a receiving unit, configured to receive information of a friendship circle released by a first user;
a determining unit, configured to determine whether a second user in the friendship circle of the first user has permitted the first user to access a friendship circle of the second user; and
a sending unit, configured to, based on a determination that the second user in the friendship circle of the first user has permitted the first user to access the friendship circle of the second user, send the information of the friendship circle released by the first user to a third user in the friendship circle of the second user, wherein the third user is not a user belonging to the friendship circle of the first user.

10. The device of claim 9, wherein the receiving unit is further configured to receive, from the first user, an access request before receiving the information of the friendship circle released by the first user, wherein the access request is used to instruct the second user to designate all or part of friends in the friendship circle of the second user as the third user for the first user to access, wherein the sending unit is further configured to forward the access request to the second user, wherein the determining unit is further configured to determine whether the access request is accepted by the second user, and wherein the device further comprises:
a first recording unit, configured to record the first user and the third user as an association based on a determination that the determining unit determines that the access request is accepted by the second user.

11. The device of claim 10, wherein the determining unit is further configured to determine whether the information released by the first user meets a preset releasing requirement before sending the information released by the first user to the third user in the friendship circle of the second user, and wherein the sending unit is further configured to send the information released by the first user to the third user based on a determination that the information released by the first user meets the preset releasing requirement.

12. The device of claim 9, wherein the receiving unit is further configured to receive, from the second user, a permission request before receiving the information of the friendship circle released by the first user, wherein the permission request is used to request to designate all or part of the friends in the friendship circle of the second user as the third user for the first user to access, wherein the sending unit is further configured to forward the permission request to the first user, wherein the determining unit is further configured to determine whether the permission request is accepted by the first user, and wherein the device further comprises:
a second recording unit, configured to record the first user and the third user as an association based on a determination that the determining unit determines that the permission request is accepted by the first user.

13. The device of claim 12, wherein the determining unit is further configured to determine whether the information released by the first user meets a preset releasing requirement before sending the information released by the first user to the third user in the friendship circle of the second user, and wherein the sending unit is further configured to send the information released by the first user to the third user based on a determination that the information released by the first user meets the preset releasing requirement.

14. The device of claim 9, wherein the sending unit comprises:
a searching module, configured to search for a user identifier of the third user; and
a sending module, configured to send the information released by the first user to the third user by using the user identifier of the third user as an index.

15. The device of claim 14, wherein the determining unit is further configured to determine whether the information released by the first user meets a preset releasing requirement before sending the information released by the first user to the third user in the friendship circle of the second user, and wherein the sending unit is further configured to send the information released by the first user to the third user based on a determination that the information released by the first user meets the preset releasing requirement.

16. The device of claim 9, wherein the determining unit is further configured to determine whether the information released by the first user meets a preset releasing requirement before sending the information released by the first user to the third user in the friendship circle of the second user, and wherein the sending unit is further configured to sending the information released by the first user to the third user based on a determination that the information released by the first user meets the preset releasing requirement.

17. An apparatus, comprising:
a memory configured to store computer-readable program instructions; and
a processor configured to execute the computer-readable program instructions to:
receive information of a friendship circle released by a first user;
determine whether a second user in the friendship circle of the first user has permitted the first user to access a friendship circle of the second user; and
based on a determination that the second user in the friendship circle of the first user has permitted the first user to access the friendship circle of the second user, sending the information of the friendship circle released by the first user to a third user in the friendship circle of the second user, wherein the third user is not a user belonging to the friendship circle of the first user.

18. A computer-readable storage medium configured to store computer-readable program instructions, wherein the computer-readable program instructions are executed at an apparatus to:
receive information of a friendship circle released by a first user;
determine whether a second user in the friendship circle of the first user has permitted the first user to access a friendship circle of the second user; and
based on a determination that the second user in the friendship circle of the first user has permitted the first user to access the friendship circle of the second user, sending the information of the friendship circle released by the first user to a third user in the friendship circle of the second user, wherein the third user is not a user belonging to the friendship circle of the first user.
